(19) United States
(12) Patent Application Publication
(10) Pub. No.: US 2026/0259970 A1
(43) Pub. Date: Sep. 3, 2026

(54) INTEGRATED MULTIFACTOR CREDENTIAL READER WITH FACIAL AUTHENTICATION

(71) Applicants: Martin Janiak, Middleton, WI (US); Kevin Booth, Middleton, WI (US); Mark Depp, Middleton, WI (US)

(72) Inventors: Martin Janiak, Middleton, WI (US); Kevin Booth, Middleton, WI (US); Mark Depp, Middleton, WI (US)

(21) Appl. No.: 19/660,037

(22) Filed: Apr. 27, 2026

Related U.S. Application Data
(63) Continuation-in-part of application No. 18/947,925, filed on Nov. 14, 2024.

(51) Int. Cl. G06F 21/32; G06F 21/34

(52) U.S. Cl. CPC G06F 21/32; G06F 21/34

(57) ABSTRACT

An integrated multifactor credential reader includes a housing, a credential reader disposed within the housing and configured to read digital credentials, a sensor array disposed on the housing and configured to acquire a live facial image of an individual, a facial image processor disposed within the housing and configured to compare the live facial image to a digital facial image, and a processor disposed within the housing. The processor is configured to read a digitized facial image from a credential via the credential reader, submit the digitized facial image to the facial image processor, and instruct the facial image processor to acquire the live facial image and compare the live facial image to the digitized facial image.

### CROSS-REFERENCE TO RELATED APPLICATIONS

This application is a Continuation-in-Part Utility Patent application claiming priority to U.S. patent application Ser. No. 18/947,925, filed on Nov. 14, 2024, which is incorporated by reference herein in its entirety.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The present disclosure relates to access control systems and credential-based identity verification, and more particularly to an integrated multifactor credential reader that combines credential reading, live facial image acquisition, and facial image comparison within a single device for real-time authentication.

### 2) Description of Related Art

Access control systems are widely used to ensure that only authorized persons have access to physical locations or controlled data. Many current access control systems utilize credentials with unique data sets that allow each credential to be associated with only the individual to whom it is issued. Credentials may take various forms, including printed badges, smart cards that communicate through physical or radio frequency interfaces, or electronic devices such as cell phones that utilize Bluetooth or similar technology.

Typical credential-based access control systems consist of a credential reader, a computer to manage a database of authorized users, and a door controller. When a credential is presented, the reader acquires information from the credential and transmits it to the database computer, which authenticates the credential information to determine if access should be authorized.

Many current access control systems authorize access based solely on the contents of the credential without any authentication of the individual presenting the credential. A personal identification number (PIN) can be associated with a credential as a second authentication factor. However, even with PIN verification, such systems may not ensure that the individual presenting the credential is the authorized owner of that credential.

Biometric authentication provides a method to verify that an individual is who they claim to be. Forms of biometric authentication include fingerprint matching, iris matching, and facial image matching. Some facial image matching systems match a live image to a picture printed on a credential, though the accuracy of this method can be affected by the quality of the printed image and ambient lighting conditions. Other methods of facial image matching involve comparison of a live image to image data stored externally, which may require transmission of the entire live image to an external system to perform the matching.

Existing facial imaging systems are often composed of separate components for the credential interface, facial image acquisition, image transmission, and image comparison. These systems may require external wiring for interconnection, additional physical space, and greater costs. Accordingly, improvements in access control systems and identity verification methods continue to be of interest.

### BRIEF SUMMARY OF THE INVENTION

According to an aspect of the present disclosure, an integrated multifactor credential reader is provided. The integrated multifactor credential reader includes a housing, a credential reader configured to read digital credentials, a facial image processor configured to acquire a live facial image and compare the live facial image to a digital facial image, and a processor configured to read a digitized facial image from a credential via the credential reader and submit the digital facial image to the facial image processor for comparison to the live facial image. All components required to read digital credentials, acquire a live facial image, compare the live facial image to a digital image stored within a credential, and communicate with a physical access control system are combined within the single housing.

According to other aspects of the present disclosure, the integrated multifactor credential reader may include one or more of the following features. The credential may be a smart card based on ISO-IEC 7816 or ISO-IEC 14443 standards. The credential may conform to the requirements defined by the Federal Information Processing Standard (FIPS) 201. The credential may be a digital device utilizing near field communications (NFC). The integrated multifactor credential reader may be configured to operate in one, two, or three factor authentication modes. The integrated multifactor credential reader may be configured to operate as a stand-alone access controller. The integrated multifactor credential reader may be configured to operate as a component of a larger access control system. The processor may be configured to perform PIN verification with the credential. The processor may be configured to generate a control signal to control an external device such as a door controller following a successful facial image match. The processor may be configured to transmit credential data to a physical access control system following a successful facial image match. The processor may be configured to transmit a message including a digital signature of the facial image read from the credential to allow the physical access control system to verify the facial image read from the credential was the same image that was written to the credential when it was issued.

According to another aspect of the present disclosure, a method of identity verification is provided. The method includes presenting a credential to an integrated multifactor credential reader. The method includes reading, under control of an embedded processor, a digital facial image encoded within the credential. The method includes acquiring, by a facial image processor, a live image of an individual presenting the credential. The method includes comparing, by the facial image processor, the live image to the digital image read from the credential. The method includes providing an indication to the user that the image has been successfully matched when the facial image processor determines that the live image matches the digital image. The method includes generating a control signal to control an external device following a successful match.

According to other aspects of the present disclosure, the method may include one or more of the following features. The method may include reading a portion of the credential data that uniquely identifies the credential holder. The method may include performing a PIN verification with the credential. The method may include transmitting credential data to a physical access control system to indicate the credential is authorized for access and the individual in possession of the credential is the authorized holder of the credential. The method may include transmitting a message to the physical access control system including a digital signature of the facial image read from the credential.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a block diagram of an access control system incorporating an integrated multifactor credential reader, according to aspects of the present disclosure.

FIG. 2 illustrates a perspective view of an integrated multifactor credential reader, according to aspects of the present disclosure.

FIG. 3 illustrates a flowchart for a method of using an integrated multifactor credential reader in a stand-alone mode, according to aspects of the present disclosure.

FIG. 4 illustrates a flowchart for a method of using an integrated multifactor credential reader as an autonomous component of an access control system, according to aspects of the present disclosure.

FIG. 5 illustrates a flowchart for a method of using an integrated multifactor credential reader in a high assurance access control system, according to aspects of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

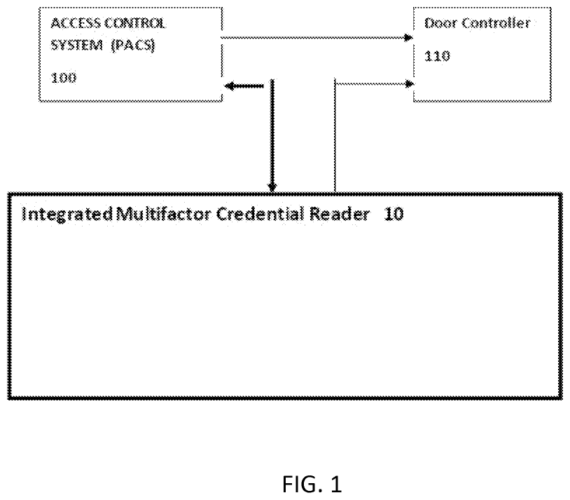

Referring to FIG. 1, an access control system 100 incorporates an integrated multifactor credential reader 10. The integrated multifactor credential reader 10 provides an electronic method of verifying that a person possessing an identity credential is the authorized holder of that credential. The integrated multifactor credential reader 10 combines credential reading, live facial image acquisition, and facial image comparison within a single enclosure. All components required to read digital credentials, acquire a live facial image, compare the live facial image to a digital image stored within a credential, and communicate with a physical access control system are combined in the integrated multifactor credential reader 10.

The integrated multifactor credential reader 10 operates as a card reader component of the access control system 100. When an individual desires access through a door or turnstile, a credential is presented to the integrated multifactor credential reader 10. The integrated multifactor credential reader includes a processor 30 and a facial image processor 40. The processor 30 reads a digitized facial image from the credential via credential reader 20. The processor 30 submits the digital image to the facial image processor 40. The processor 30 instructs the facial image processor 40 to acquire a live image and compare the live image to the digital image. The integrated multifactor credential reader 10 communicates the result of the match attempt to the access control system 100.

Credential-based identity verification using facial image matching provides a method of identity verification that is fast and reliable. Credential-based identity verification using facial image matching requires no physical contact between the user and the integrated multifactor credential reader 10. Matching a live facial image with a digital image securely stored on a credential provides positive verification of ownership of the credential. If a live facial image of the person presenting the credential matches stored facial image data associated with the credential, there is a high level of confidence that the credential holder is the authorized owner.

With continued reference to FIG. 1, the incorporation of all required components within a single enclosure improves security, reliability, ease of support, and cost versus individual components wired together. Because the integrated multifactor credential reader 10 performs the matching of the image, the need to transmit the entire image to an external computer for matching is eliminated. By incorporating all of the components within a single enclosure, physical space requirements, system complexity, and costs are reduced.

Referring to FIG. 1, an access control system 100 incorporates an integrated multifactor credential reader 10. The integrated multifactor credential reader 10 includes a credential reader 20, a processor 30, and a facial image processor 40. The integrated multifactor credential reader 10 operates as a card reader component of the access control system 100. When an individual desires access through a door or turnstile, a credential is presented to the integrated multifactor credential reader 10.

The processor 30 reads digitized facial image data from credentials via the credential reader 20. The processor 30 submits the digital image to the facial image processor 40. The processor 30 instructs the facial image processor 40 to acquire a live image and compare the live image to the digital image. The integrated multifactor credential reader 10 communicates the result of the match attempt to the access control system 100.

With continued reference to FIG. 1, the facial image processor 40 is configured to acquire a live facial image of an individual presenting a credential and compare the live image to the digital image read from the credential. The processor 30 communicates bidirectionally with the facial image processor 40 to instruct the acquisition and comparison of images. The integrated multifactor credential reader 10 incorporates all components within a single enclosure, including the credential reader 20, the processor 30, and the facial image processor 40.

The integrated multifactor credential reader 10 supports various credential types. A credential is a physical object such as a smart card or a derived object stored in an electronic device such as a cell phone. Credentials communicate through either a physical interface or a radio frequency (RF) interface. In some configurations, credentials utilize Bluetooth or similar technology for communication with the integrated multifactor credential reader 10.

The integrated multifactor credential reader 10 supports smart cards based on ISO-IEC 7816 standards, which define contact-based smart card interfaces. The integrated multifactor credential reader 10 also supports smart cards based on ISO-IEC 14443 standards, which define contactless proximity card interfaces. Credentials conforming to the requirements defined by the Federal Information Processing Standard (FIPS) 201 are supported by the integrated multifactor credential reader 10. FIPS 201 defines the requirements for Personal Identity Verification (PIV) credentials issued by the U.S. Government. The integrated multifactor credential reader 10 further supports digital devices utilizing near field communications (NFC) interfaces.

As further shown in FIG. 1, the integrated multifactor credential reader 10 communicates the result of the facial image match attempt to external systems such as a physical access control system (PACS). The PACS includes a computer to manage a database of authorized users. When the integrated multifactor credential reader 10 determines that a live facial image matches a digital image stored on a credential, the processor 30 transmits credential data to the PACS to indicate the credential is authorized for access and the individual in possession of the credential is the authorized holder of the credential.

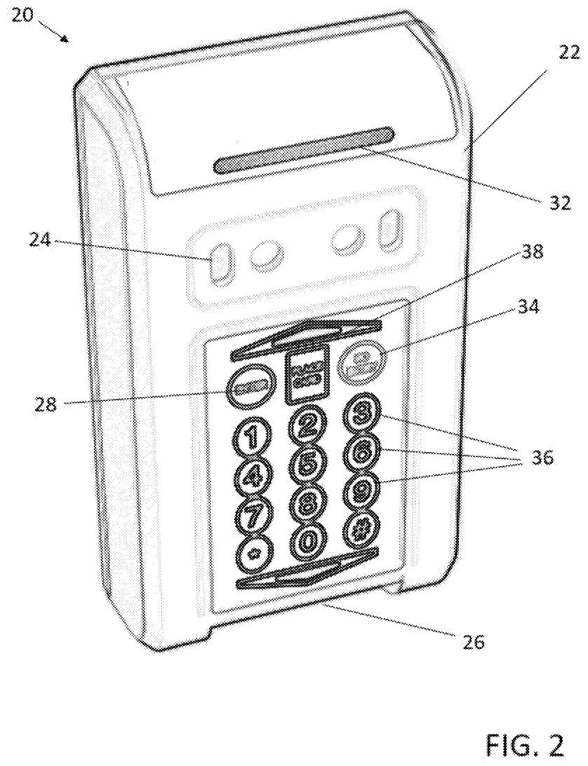

Referring to FIG. 2, the integrated multifactor credential reader 10 includes a housing 22 that encloses and supports the various components of the device. The housing 22 provides a single enclosure that contains all components required to read digital credentials, acquire a live facial image, compare the live facial image to a digital image stored within a credential, and communicate with a physical access control system.

A sensor array 24 is positioned on a front face of the housing 22. The video sensors of the sensor array 24 provide capability for acquiring live facial images of individuals presenting credentials to the integrated multifactor credential reader 10.

With continued reference to FIG. 2, a slot 26 is provided on the housing 22 for card insertion. The slot 26 allows credentials to be physically inserted into the integrated multifactor credential reader 10 for reading. A place card indicator 38 is positioned on the front face of the housing 22. The place card indicator 38 includes an arrow that guides users on the proper location for card placement when using contactless credentials. The place card indicator 38 directs users to position contactless credentials at the appropriate location on the integrated multifactor credential reader 10 for communication via radio frequency interfaces.

The integrated multifactor credential reader 10 includes a speaker 32 located near a top portion of the housing 22. The speaker 32 provides audio feedback to users during operation of the integrated multifactor credential reader 10.

As further shown in FIG. 2, the integrated multifactor credential reader 10 features several user interface elements. Numerical buttons 36 are arranged in a standard keypad configuration on the front face of the housing 22. The numerical buttons 36 provide capability for PIN entry during two or three factor authentication operations. A no entry indicator 34 is positioned on the front face of the housing 22 for signaling when access is denied. An entry indicator 28 is positioned on the front face of the housing for signaling when access is granted.

The integrated multifactor credential reader 10 combines all components required for credential reading, facial image acquisition, image comparison, and communication with an access control system within the single housing 22. The incorporation of all required components within the single housing 22 reduces physical space requirements and eliminates the need for external wiring between separate components.

Referring to FIG. 1, the processor 30 and the facial image processor 40 interact to perform identity verification within the integrated multifactor credential reader 10. When a credential is presented to the integrated multifactor credential reader 10, the processor 30 reads a digitized facial image from the credential via a credential reader interface. The processor 30 submits the digital image to the facial image processor 40. The processor 30 instructs the facial image processor 40 to acquire a live image and compare the live image to the digital image. The facial image processor 40 performs the matching of the live facial image to the digital image internally within the integrated multifactor credential reader 10. Because the facial image processor 40 performs the matching internally, the need to transmit the entire image to an external computer for matching is eliminated.

With continued reference to FIG. 1, the digital image data stored on the credential is not affected by external lighting conditions that affect external camera systems. The digital image stored on the credential remains consistent regardless of ambient lighting at the location where the integrated multifactor credential reader 10 is installed. The facial image processor 40 compares the live facial image acquired by the sensor array 24 to the digital image read from the credential to determine whether the images match.

Referring to FIG. 2, the integrated multifactor credential reader 10 is configured to provide one, two, or three factor authentication. In a one factor authentication mode, the integrated multifactor credential reader 10 verifies the credential data to confirm the credential is valid. In a two-factor authentication mode, the integrated multifactor credential reader 10 performs PIN verification with the credential in addition to verifying the credential data. The numerical buttons 36 on the housing 22 provide capability for a user to enter a PIN during two or three factor authentication operations. PIN verification serves as a second authentication factor that confirms the individual presenting the credential possesses knowledge associated with the credential.

As further shown in FIG. 2, in a three-factor authentication mode, the integrated multifactor credential reader 10 performs credential verification, PIN verification, and facial image matching. The facial image matching serves as a third authentication factor that verifies the individual presenting the credential is the authorized holder of the credential. The sensor array 24 acquires a live facial image of the individual presenting the credential. The facial image processor 40 compares the live facial image to the digital facial image stored on the credential. When the facial image processor 40 determines that the live image matches the digital image, the integrated multifactor credential reader 10 confirms that the individual in possession of the credential is the authorized holder of the credential.

Referring to FIG. 1, the integrated multifactor credential reader 10 operates as a stand-alone access controller or as a component of a larger access control system. When operating as a stand-alone access controller, the processor 30 generates a control signal to control an external device such as a door controller following a successful facial image match. When operating as a component of a larger access control system, the processor 30 transmits credential data to a physical access control system (PACS) 100 following a successful facial image match. The PACS includes a computer to manage a database of authorized users and determines whether the credential is authorized for access at a particular location.

With continued reference to FIG. 1, the processor 30 communicates bi-directionally with the facial image processor 40 to coordinate the acquisition and comparison of images. The processor 30 receives the result of the match attempt from the facial image processor 40. The integrated multifactor credential reader 10 communicates the result of the match attempt to the access control system 100. The incorporation of the credential reader 20, the processor 30, and the facial image processor 40 within a single enclosure eliminates the need for external wiring between separate components and reduces physical space requirements.

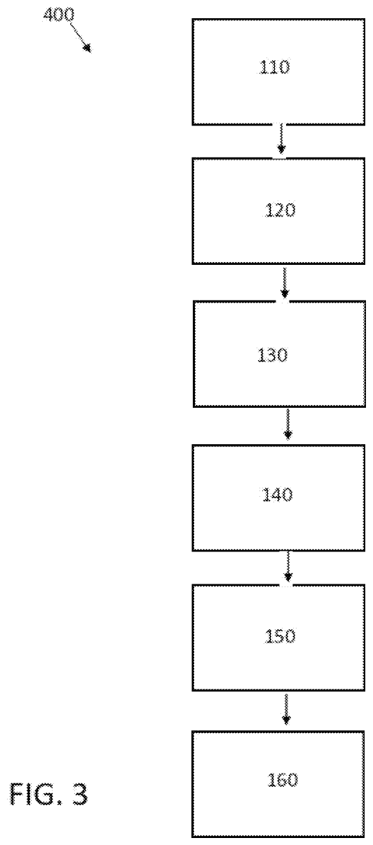

Referring to FIG. 3, a method 400 illustrates operation of the integrated multifactor credential reader 10 in a stand-alone mode. The stand-alone mode allows the integrated multifactor credential reader 10 to function as an access controller without requiring connection to an external physical access control system (PACS) or external database.

The method 400 begins with a step 110 wherein a credential is presented to the integrated multifactor credential reader 10. The credential is positioned at the slot 26 for contact-based credentials or at the place card indicator 38 for contactless credentials.

In a step 120, under control of the processor 30, the integrated multifactor credential reader 10 reads a digital facial image encoded within the credential. The processor 30 retrieves the digitized facial image data stored on the credential via a credential reader interface.

With continued reference to FIG. 3, in a step 130, the facial image processor 40 acquires a live image of the individual presenting the credential and compares the live image to the digital image read from the credential. The sensor array 24 captures the live facial image of the individual. The facial image processor 40 performs the comparison internally within the integrated multifactor credential reader 10.

The method 400 proceeds to a step 140 following the comparison process performed by the facial image processor 40. In a step 150, when the facial image processor 40 determines that the live image matches the digital image, the processor 30 provides an indication to the user that the image has been successfully matched. The indication confirms to the user that identity verification has been completed.

As further shown in FIG. 3, in a step 160, following a successful match, the processor 30 generates a control signal. The control signal is used to control an external device such as a door controller or a turnstile. The control signal authorizes access based on the successful facial image match performed by the integrated multifactor credential reader 10.

The stand-alone mode of operation allows the integrated multifactor credential reader 10 to perform complete identity verification and access control without transmitting credential data or facial images to external systems. The processor 30 determines access authorization based on the result of the facial image comparison performed by the facial image processor 40. The control signal generated by the processor 30 interfaces directly with external access control hardware to grant or deny physical access.

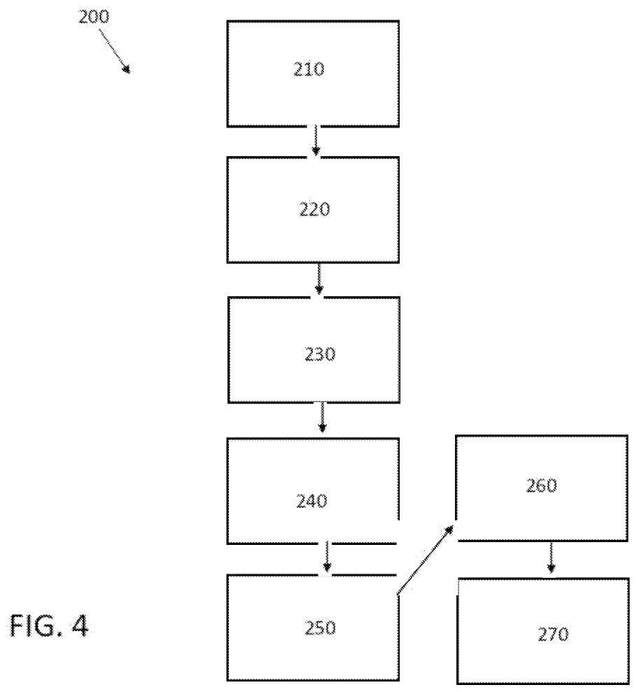

Referring to FIG. 4, a method 200 illustrates operation of the integrated multifactor credential reader 10 as an autonomous component of a standard access control system. The autonomous component mode allows the integrated multifactor credential reader 10 to perform facial image matching independently while communicating with a physical access control system (PACS) 100 for final access authorization.

The method 200 begins with a step 210 wherein a credential is presented to the integrated multifactor credential reader 10. The credential is positioned at the slot 26 for contact-based credentials or at the place card indicator 38 for contactless credentials.

In a step 220, under control of the processor 30, the integrated multifactor credential reader 10 reads a portion of the credential data. The credential data includes a credential number that uniquely identifies the credential holder. The credential number serves as a unique identifier that associates the credential with a specific authorized individual in the PACS database.

With continued reference to FIG. 4, in a step 230, when the integrated multifactor credential reader 10 is operating in two or three factor authentication mode, the integrated multifactor credential reader 10 performs a PIN verification with the credential. The numerical buttons 36 on the housing 22 provide capability for a user to enter a PIN. The PIN verification confirms that the individual presenting the credential possesses knowledge associated with the credential.

In a step 240, when the PIN verification is successful or when a PIN verification is not required, the integrated multifactor credential reader 10 reads the facial image file encoded within the credential. The processor 30 retrieves the digitized facial image data stored on the credential via a credential reader interface.

As further shown in FIG. 4, in a step 250, under control of the processor 30, the facial image processor 40 acquires a live facial image and compares the live facial image to the digital image read from the credential. The sensor array 24 captures the live facial image of the individual presenting the credential. The facial image processor 40 performs the comparison internally within the integrated multifactor credential reader 10.

In a step 260, when the facial image processor 40 determines that the images match, the processor 30 transmits the credential data to the PACS 100. The credential data identifies the unique credential to the PACS 100. The transmission to the PACS 100 indicates that the credential is authorized for access at the location of the integrated multifactor credential reader 10 and that the individual in possession of the credential is the authorized holder of the credential.

With continued reference to FIG. 4, in a step 270, the PACS 100 compares the credential information against a database of authorized users. When the PACS 100 determines that the credential is valid at the location of the integrated multifactor credential reader 10, the PACS 100 signals a door controller 110 to allow access.

The autonomous component mode of operation allows the integrated multifactor credential reader 10 to perform complete identity verification through facial image matching before transmitting credential data to the PACS 100. The PACS 100 receives credential data only after the integrated multifactor credential reader 10 confirms that the individual presenting the credential is the authorized holder of the credential. The PACS 100 performs final access authorization based on the credential data and the database of authorized users.

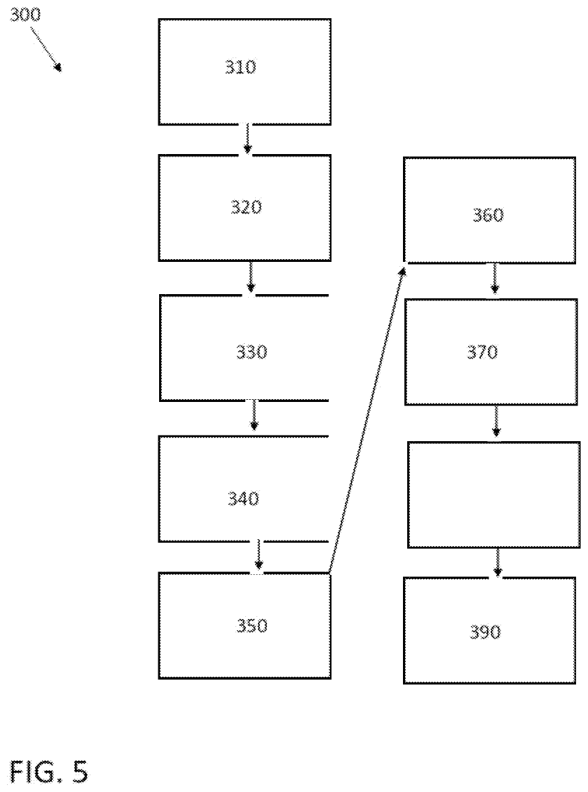

Referring to FIG. 5, a method 300 illustrates operation of the integrated multifactor credential reader 10 as a component in a high assurance access control system. The high assurance access control system mode allows a physical access control system (PACS) 100 to request specific authentication levels based on the credential presented and the security requirements of the location.

The method 300 begins with a step 310 wherein a credential is presented to the integrated multifactor credential reader 10. The credential is positioned at the slot 26 for contact-based credentials or at the place card indicator 38 for contactless credentials.

In a step 320, under control of the processor 30, the integrated multifactor credential reader 10 reads a portion of the credential data. The credential data includes a credential number that uniquely identifies the credential holder. The credential number serves as a unique identifier that associates the credential with a specific authorized individual in the PACS database.

With continued reference to FIG. 5, in a step 330, under control of the processor 30, the integrated multifactor credential reader 10 transmits the credential data to the PACS 100. The PACS 100 receives the credential data and determines whether the credential is authorized at the location of the integrated multifactor credential reader 10.

In a step 340, when the PACS 100 determines the credential is authorized at the location, the PACS 100 transmits a request to the processor 30 to perform a two or three factor transaction. The PACS 100 determines the authentication level required based on security policies associated with the location and the credential. The PACS requests specific authentication levels by transmitting instructions to the processor 30 indicating whether PIN verification and facial image matching are required for the transaction.

As further shown in FIG. 5, in a step 350, when a two or three factor transaction has been requested by the PACS, the integrated multifactor credential reader 10 performs a PIN verification with the credential. The numerical buttons 36 on the housing 22 provide capability for a user to enter a PIN. The PIN verification confirms that the individual presenting the credential possesses knowledge associated with the credential.

In a step 360, when the PIN verification is successful or when a PIN verification is not required, the integrated multifactor credential reader 10 reads the facial image file encoded within the credential. The processor 30 retrieves the digitized facial image data stored on the credential via a credential reader interface 20.

With continued reference to FIG. 5, in a step 370, under control of the processor 30, the facial image processor 40 acquires a live facial image and compares the live facial image to the digital image read from the credential. The sensor array 24 captures the live facial image of the individual presenting the credential. The facial image processor 40 performs the comparison internally within the integrated multifactor credential reader 10.

In a step 380, when the facial image processor 40 determines that the images match, the processor 30 transmits a message to the PACS 100 to indicate the successful match. The message may include a digital signature of the facial image read from the credential. The digital signature allows the PACS to verify that the facial image read from the credential was the same image that was written to the credential when the credential was issued. The digital signature confirms that the image data has not been tampered with since the credential was issued. The digital signature provides verification that the facial image currently stored on the credential is authentic and has not been altered or replaced.

As further shown in FIG. 5, in a step 390, upon receiving the message indicating the successful match, the PACS 100 signals a door controller 110 to allow access. The PACS 100 authorizes access based on the successful facial image match and the verification provided by the digital signature.

The high assurance access control system mode of operation allows the PACS 100 to maintain control over the authentication level required for each transaction. The PACS 100 determines whether one, two, or three factor authentication is required based on security policies. The integrated multifactor credential reader 10 performs the requested authentication operations and reports the results to the PACS 100. The inclusion of the digital signature in the message transmitted to the PACS provides an additional level of assurance that the facial image used for matching is the authentic image originally encoded on the credential when issued by a trusted authority.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An integrated multifactor credential reader, comprising:
a housing;
a credential reader disposed within the housing and configured to read digital credentials;
a sensor array disposed on the housing and configured to acquire a live facial image of an individual;
a facial image processor disposed within the housing and configured to compare the live facial image to a digital facial image; and
a processor disposed within the housing and configured to:
read a digitized facial image from a credential via the credential reader;
submit the digitized facial image to the facial image processor; and
instruct the facial image processor to acquire the live facial image and compare the live facial image to the digitized facial image.

2. The integrated multifactor credential reader of claim 1, wherein the credential reader is configured to read smart cards based on ISO-IEC 7816 standards.

3. The integrated multifactor credential reader of claim 1, wherein the credential reader is configured to read smart cards based on ISO-IEC 14443 standards.

4. The integrated multifactor credential reader of claim 1, wherein the credential reader is configured to read credentials conforming to Federal Information Processing Standard 201.

5. The integrated multifactor credential reader of claim 1, wherein the credential reader is configured to read digital devices utilizing near field communications.

6. The integrated multifactor credential reader of claim 1, further comprising numerical buttons disposed on the housing, wherein the processor is configured to perform PIN verification with the credential using input received via the numerical buttons.

7. The integrated multifactor credential reader of claim 1, wherein the processor is configured to generate a control signal to control an external device following a determination by the facial image processor that the live facial image matches the digitized facial image.

8. The integrated multifactor credential reader of claim 1, wherein the processor is configured to transmit credential data to a physical access control system following a determination by the facial image processor that the live facial image matches the digitized facial image.

9. The integrated multifactor credential reader of claim 8, wherein the processor is configured to transmit a message including a digital signature of the digitized facial image read from the credential to the physical access control system.

10. The integrated multifactor credential reader of claim 1, wherein the integrated multifactor credential reader is configured to operate in a one factor authentication mode, a two-factor authentication mode, or a three-factor authentication mode.

11. A method of identity verification, comprising:
presenting a credential to an integrated multifactor credential reader;
reading, by a processor of the integrated multifactor credential reader, a digital facial image encoded within the credential;
acquiring, by a facial image processor of the integrated multifactor credential reader, a live facial image of an individual presenting the credential;
comparing, by the facial image processor, the live facial image to the digital facial image read from the credential; and
generating, by the processor, a control signal to control an external device when the facial image processor determines that the live facial image matches the digital facial image.

12. The method of claim 11, further comprising providing an indication to the individual that the live facial image has been successfully matched to the digital facial image.

13. The method of claim 11, further comprising reading, by the processor, a credential number from the credential that uniquely identifies a credential holder.

14. The method of claim 11, further comprising performing, by the processor, a PIN verification with the credential prior to reading the digital facial image encoded within the credential.

15. The method of claim 11, further comprising transmitting, by the processor, credential data to a physical access control system to indicate that the credential is authorized for access and that the individual in possession of the credential is an authorized holder of the credential.

16. The method of claim 15, further comprising transmitting, by the processor, a message including a digital signature of the digital facial image read from the credential to the physical access control system.

17. An access control system, comprising:
an integrated multifactor credential reader including:
a housing;
a credential reader disposed within the housing and configured to read a digitized facial image from a credential;
a sensor array disposed on the housing and configured to acquire a live facial image of an individual presenting the credential;
a facial image processor disposed within the housing and configured to compare the live facial image to the digitized facial image; and
a processor disposed within the housing and configured to read the digitized facial image from the credential via the credential reader and submit the digitized facial image to the facial image processor for comparison to the live facial image; and
a physical access control system configured to receive credential data from the processor of the integrated multifactor credential reader and determine whether the credential is authorized for access at a location of the integrated multifactor credential reader.

18. The access control system of claim 17, wherein the physical access control system is configured to transmit a request to the processor to perform a two factor or three factor authentication transaction based on security policies associated with the location.

19. The access control system of claim 17, wherein the processor is configured to transmit a message to the physical access control system indicating a successful match when the facial image processor determines that the live facial image matches the digitized facial image.

20. The access control system of claim 19, wherein the message includes a digital signature of the digitized facial image read from the credential to allow the physical access control system to verify that the digitized facial image read from the credential is a same image that was written to the credential when the credential was issued.
